(19) United States
(12) Patent Application Publication
(10) Pub. No.: US 2026/0260158 A1
(43) Pub. Date: Sep. 3, 2026

(54) APPARATUSES AND METHODS FOR FACILITATING ADAPTIVE MODEL COMPRESSION AND DECOMPRESSION FOR INFERENCE TASKS AND DYNAMIC RESOURCE-BASED COMPRESSION STRATEGIES FOR NETWORKS AND SYSTEMS

(71) Applicant: AT&T Intellectual Property I, L.P., Altanta, GA (US)

(72) Inventors: Rohit Abhishek, Dawsonville, GA (US); Mohamed Khalil, Murphy, TX (US); Farooq Bari, Kirkland, WA (US)

(73) Assignee: AT&T Intellectual Property I, L.P., Atlanta, GA (US)

(21) Appl. No.: 19/066,365

(22) Filed: Feb. 28, 2025

(51) Int. Cl. G06N 20/00; H04L 41/16

(52) U.S. Cl. CPC G06N 20/00; H04L 41/16

(57) ABSTRACT

Aspects of the subject disclosure may include, for example, identifying resources available at an edge node of a network, resulting in a first identification, identifying at least one requirement associated with a communication service facilitated by the edge node, resulting in a second identification, determining, based on the first identification and the second identification, a first compression that is to be applied to a model that facilitates the communication service, resulting in a determination, applying, based on the determination, the first compression to the model, resulting in a compressed model, and providing the compressed model to the edge node. Other embodiments are disclosed.

### FIELD OF THE DISCLOSURE

The subject disclosure relates to apparatuses and methods for facilitating adaptive model compression and decompression for inference tasks and dynamic resource-based compression strategies for networks and systems.

### BACKGROUND

Recent advancements in mobile and wireless network technologies, such as Fifth Generation (5G) and Sixth Generation (6G) networks, have introduced capabilities for massive device connectivity, low-latency communication, and high-bandwidth transmissions. These advancements have made it feasible to perform artificial intelligence/machine learning (AI/ML) inference closer to the data source at the edge of a network or system, reducing the need for data transmission to centralized cloud servers and decreasing response times.

However, edge devices, unlike centralized cloud servers, are constrained by limited processing power/resources, memory, and energy. As AI/ML models grow in complexity, running/executing these models on constrained edge nodes presents significant challenges. The existing methods of model compression and inference are not enhanced (e.g., optimized) for such environments, necessitating dynamic adjustments based on real-time resource and network conditions.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system in accordance with various aspects described herein.

FIGS. 2B-2C depicts illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for facilitating adaptive model compression and decompression techniques in respect of inference tasks and facilitating dynamic resource-based compression strategies for networks and systems. Other embodiments are described in the subject disclosure.

One or more aspects of the subject disclosure include, in whole or in part, identifying resources available at an edge node of a network, resulting in a first identification; identifying at least one requirement associated with a communication service facilitated by the edge node, resulting in a second identification; determining, based on the first identification and the second identification, a first compression that is to be applied to a model that facilitates the communication service, resulting in a determination; applying, based on the determination, the first compression to the model, resulting in a compressed model; and providing the compressed model to the edge node.

One or more aspects of the subject disclosure include, in whole or in part, obtaining first data pertaining to real-time network data and resource data associated with a network; obtaining second data pertaining to a prediction of congestion, mobility, and traffic loads as part of the network; processing the first data and the second data to identify a compression that is to be applied to a model supporting a communication service provisioned by the network; applying the compression to the model, resulting in a compressed model; and transmitting the compressed model to a node of the network

One or more aspects of the subject disclosure include, in whole or in part, obtaining, by a processing system including a processor, a compressed model; evaluating, by the processing system, resources available at the processing system to identify a decompression that is to be applied to the compressed model, resulting in an identified decompression; decompressing, by the processing system, the compressed model in accordance with the identified decompression, resulting in a decompressed model; and utilizing, by the processing system, the decompressed model to generate an inference.

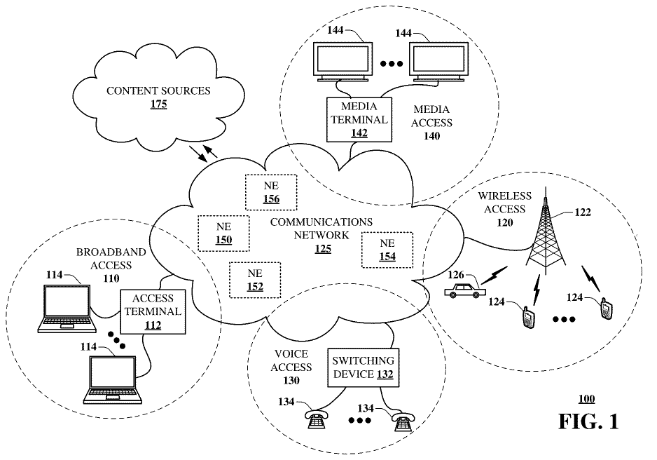

Referring now to FIG. 1, a block diagram is shown illustrating an example, non-limiting embodiment of a system 100 in accordance with various aspects described herein. For example, the system 100 can facilitate, in whole or in part, identifying resources available at an edge node of a network, resulting in a first identification, identifying at least one requirement associated with a communication service facilitated by the edge node, resulting in a second identification, determining, based on the first identification and the second identification, a first compression that is to be applied to a model that facilitates the communication service, resulting in a determination, applying, based on the determination, the first compression to the model, resulting in a compressed model, and providing the compressed model to the edge node. The system 100 can facilitate, in whole or in part, obtaining first data pertaining to real-time network data and resource data associated with a network, obtaining second data pertaining to a prediction of congestion, mobility, and traffic loads as part of the network, processing the first data and the second data to identify a compression that is to be applied to a model supporting a communication service provisioned by the network, applying the compression to the model, resulting in a compressed model, and transmitting the compressed model to a node of the network. The system 100 can facilitate, in whole or in part, obtaining, by a processing system including a processor, a compressed model, evaluating, by the processing system, resources available at the processing system to identify a decompression that is to be applied to the compressed model, resulting in an identified decompression, decompressing, by the processing system, the compressed model in accordance with the identified decompression, resulting in a decompressed model, and utilizing, by the processing system, the decompressed model to generate an inference.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, aspects of this disclosure may be utilized to address challenges that exist in the conventional state of the art. These challenges include, or pertain to: resource constraints, dynamic network/system conditions, energy efficiency, scalability, lossless versus lossy compression, inter-node coordination and distributed inference generation, and generative artificial intelligence (Gen AI) for enhancement (e.g., optimization).

In terms of resource constraints, edge devices are typically limited in terms of available processing power/resources, memory, and energy. Running large, complex artificial intelligence/machine learning (AI/ML) models in such environments requires careful management of resources.

In terms of dynamic network/system conditions, network/system environments, especially in 5G and 6G, are highly dynamic. Parameters such as signal to interference plus noise ratio (SINR), reference signal received power (RSRP), channel quality indicator (CQI), latency, and bandwidth fluctuate based on user mobility, connection density, and device handovers between cells. These and other variations directly impact the performance of AI/ML inference generation and may necessitate real-time adjustments to model compression strategies.

In terms of energy efficiency, edge devices, especially battery-powered ones, may need to operate under strict power constraints. Running AI/ML models in such devices may require careful balancing between computational intensity and energy consumption. Without energy-efficient compression methods, battery life may be severely impacted.

In terms of scalability, AI/ML models are growing more complex, and edge devices must be able to handle a wide variety of tasks, from simple sensor data processing to complex computer vision applications. Ensuring that network/systems can dynamically scale and distribute workloads across edge nodes is a key challenge.

In terms of lossless versus lossy compression, ensuring accuracy in AI/ML inference generation may require a selection of appropriate compression techniques. In many cases, lossless compression is needed to preserve model fidelity, but this comes at a high resource cost. Conversely, lossy compression offers resource savings at the potential expense of inference accuracy. Balancing these trade-offs in real-time may be critical.

In terms of inter-node coordination and distributed inference generation, performing distributed AI/ML inference generation across multiple geo-located edge nodes introduces challenges in terms of coordination, communication, and model aggregation. This may become especially complex and challenging in scenarios where edge nodes are experiencing varying levels of connectivity, power availability, or computational resources.

In terms of Gen AI for enhancement, enhancing (e.g., optimizing) compression, decompression, and distributed computing strategies may require advanced techniques such as Gen AI, which can predict an enhanced (e.g., best) distribution of tasks across edge nodes and anticipate network and resource changes. Ensuring this enhancement occurs in real-time adds further complexity.

In view of the foregoing, aspects of this disclosure may include adaptive technologies that dynamically apply AI/ML model compression and decompression techniques based on real-time network/system conditions and resource availability. Aspects of this disclosure may be applied to, e.g., 5G, 6G, and future network environments, where edge devices may perform real-time AI/ML inference generation under varying conditions. Lossless and/or lossy compression techniques may be utilized to enhance (e.g., optimize) resource usage and maintain inference accuracy, depending on the available processing power/resources, bandwidth, and memory at the edge nodes.

Embodiments of this disclosure may include various functionalities, such as Geo-AI model training, hybrid compression techniques, distributed computing, model splitting, and runtime resource reservation. A dynamic adjustment of compression may be provided based on various metrics, including device connection density, SINR, RSRP, CQI, sessions (e.g., packet data unit [PDU] sessions), mobility metrics (e.g., Tracking Area Identity [TAI], cell ID, handovers), etc.

Aspects of this disclosure may leverage Gen AI models to predict enhanced (e.g., optimal) strategies for model distribution and compression. This may help to ensure energy-efficient, scalable AI/ML inference generation across distributed edge nodes, while dynamically balancing model accuracy and resource efficiency.

Adaptive AI/ML model compression and decompression techniques (pruning, quantization, knowledge distillation) may be employed at geolocated edge nodes in, e.g., 5G, 6G, and future networks. The compression technique that is selected may be dynamically adjusted based on real-time network/system and radio metrics, network data analytics function (NWDAF) insights, and the like. For example, parameters that may influence the technique that is selected/used may include or pertain to: a number of connected devices, a number of sessions (e.g., PDU sessions), quality of service (QoS) requirements, mobility metrics, radio access metrics (e.g., SINR, RSRP, CQI, radio link failures [RLFs]), throughput and data rate parameters (e.g., uplink/downlink rates, scheduling requests, Buffer Status Reports [BSRs]), resource block utilization (e.g., physical resource block [PRB] allocation), power reports (e.g., power headroom report [PHR], transmission power), signaling overhead (e.g., paging, non-access stratum [NAS] requests, re-establishment attempts), network/system slicing metrics (e.g., slice load level, user equipment [UE] behavior in slices), and NWDAF-assisted compression.

In terms of the number of connected devices, the number of active devices connected to a particular edge node may directly impact computational resources. As the number of devices increases, available resources decrease, which may prompt a switch to lossy compression to save memory and bandwidth.

In terms of the number of sessions, higher numbers of sessions create demand for increased throughput and bandwidth. In turn, this may necessitate a utilization of more efficient compression techniques.

In terms of QoS requirements, AI/ML models may need to meet various QoS requirements, such as low latency, high throughput, and reduced (e.g., minimal) jitter. Based on the required QoS, a determination may be made whether to use lossless or lossy compression to balance inference accuracy with performance.

In terms of mobility metrics, as devices move across different geographic regions and handover events occur between resources (e.g., cells), compression strategies may be adapted to handle changes in network/system topology and radio signal conditions.

In terms of radio access metrics, associated parameters may provide insight into signal strength and quality, enabling a selection of compression methods/techniques that reduced (e.g., minimize) the negative impact on inference accuracy when network/system quality degrades.

In terms of throughput and data rate parameters, high data throughput and favorable reports (e.g., favorable BSR reports) may indicate better bandwidth availability, allowing for lossless compression. Conversely, conditions of lower throughput may trigger lossy compression.

In terms of resource block utilization, an allocation of resource blocks may directly impact available bandwidth, which may tend to guide towards utilization of efficient compression techniques.

In terms of power reports, power availability on edge devices may dictate whether lossless or lossy compression is more appropriate. High power availability may allow for lossless decompression, while low power conditions may require lossy compression to conserve energy.

In terms of signaling overhead, high signaling overhead may increase latency. The increase in latency may prompt the use of faster, but potentially lossy, compression techniques to maintain QoS.

In terms of network/system slicing metrics, slicing techniques of this disclosure may dynamically allocate AI/ML models to specific slices, adjusting compression based on the slice load and user behavior within the slice. When a slice is overloaded, lossy compression may be utilized to conserve resources while maintaining throughput. Conversely, underloaded slices may benefit from a utilization of lossless compression to enhance (e.g., maximize) accuracy.

In terms of NWDAF-assisted compression, NWDAF insights into traffic load, network/system slicing conditions, and QoS parameters may directly inform the compression decision-making processes/techniques of this disclosure. In this respect, it may be possible to preemptively apply an enhanced (e.g., a most resource-efficient) compression method/technique.

Embodiments of this disclosure may manage decompression during an inference generation phase, dynamically adjusting between lossless and lossy decompression based on real-time conditions, while ensuring efficient AI/ML inference generation with reduced (e.g., minimal) latency and resource consumption. The compressed models are aggregated into a global model, enabling efficient, low-latency AI/ML inference generation across one or more networks/systems.

As referenced above, lossless compression techniques may be used to preserve the precision and structure of an AI/ML model, ensuring that there is no loss of information or degradation of inference accuracy. Lossless compression may be preferred in scenarios/instances where sufficient bandwidth, processing resources, and memory resources are available. In terms of a mathematical formula or expression, it may be stated that:

$${W}_{c o m p r e ssed , lossless} = W ,$$

where W represents the original, uncompressed model, and the lossless compression (W_{compressed, lossless}) ensures that the weights and structure of the model are preserved exactly.

In contrast to the foregoing, lossy compression techniques of this disclosure may sacrifice some degree of precision in the model weights, leading to a trade-off between inference accuracy and resource savings. Lossy compression may be used in environments where bandwidth, processing resources, or memory resources are constrained. In terms of a mathematical formula or expression, it may be stated that:

$${W}_{c o m pressed , lossy} = round ( W \cdot {Q}_{s c a l e} ) ,$$

where W_{compressed, lossy} may correspond to a weight matrix after lossy compression, Q_{scale} may correspond to a quantization scaling factor, and round( ) may correspond to a rounding operator or function. As would be appreciated by one of skill in the art, lossy compression may reduce the precision of the model weights, allowing for faster inference generation and reduced resource consumption.

In accordance with aspects of this disclosure, models may be dynamically compressed or decompressed, potentially as a function ƒ( ) of real-time resource conditions. In this regard, it may be stated that:

$${C}_{adaptive} = f ( available resources , QoS , compression type ( lossless or lossy ) ) ,$$

where C_{adaptive} refers to the adaptive compression process based on available resources and network/system conditions. Decompression may then be applied before the model is used for inference generation. In terms of decompression, lossless decompression or lossy decompression may be provided/utilized. Lossless decompression may be expressed as:

$${W}_{d e c o m p r e s sed , lossless} = {W}_{c o m p r e ssed , lossless} ,$$

where the model is restored to its original, full-precision form.

Lossy decompression may be expressed as:

$${W}_{d e c o m p r e s sed , lossy} = {W}_{c o m p r e s sed , lossy} \cdot {Q}_{- scale 1} ,$$

where W_{compressed, lossy} may be decompressed using the inverse of the quantization scaling factor Q_{scale}, resulting in a lower-precision model that is faster to compute.

Geo-AI models of this disclosure may be trained using geographical data (e.g., TAI, Cell ID, and handover events) and may be dynamically compressed before transmission/inference generation. This may ensure that models are enhanced (e.g., optimized) for the specific network/system conditions of the geographical region in which they are deployed. Lossless compression may be used when high resource availability permits, while lossy compression may be applied when there are constraints on bandwidth, processing resources, or memory. Geo-AI compression may be expressed as:
C_{geo}=ƒ(available bandwidth, energy, compression type, Geo metrics (TAI, Cell ID)),
   where Geo metrics such as TAI and handover events may influence the compression method/technique selected for models trained on geo-specific data. This may enable efficient transmission and deployment of models across different geographic regions.

For models that are too large or complex to run on a single node, the model may be (dynamically) split into sub-models that may be distributed across geo-located edge nodes. These sub-models may be compressed to reduce transmission costs, and decompression may be performed before inference generation. The decision between lossless and lossy compression may depend on the available resources of the transmitting and receiving nodes. In this respect, a model may be split into smaller sub-models Mi, each of which may be compressed before transmission. This splitting and compression may be expressed as:

$${M}_{compressed , i} = f ( {M}_{i} , compression type ) ,$$

where compression type can be lossless or lossy, based on network/system conditions. A node may decompress a sub-model before performing inference generation.

This decompression may be expressed as:

$${M}_{decompressed , i} = f ( {M}_{compressed , i} , available resources )$$

The pairing of compression and decompression with respect to sub-models set forth above may enable nodes of a network or system to collaborate in performing a distributed inference generation. It is noted that the same may be true/apply, even in resource-constrained environments.

In some embodiments, resources may be reserved to facilitate/perform compression, decompression, and inference generation. A reservation scheme may be based on real-time network/system metrics, such as PDU sessions, QoS, and slicing. Resources may be allocated efficiently to ensure that AI/ML tasks can be performed with reduced (e.g., minimal) latency and enhanced (e.g., maximal) accuracy, while still conserving bandwidth and power. Resource reservation may be expressed/stated as:

$${R}_{t otal reserved} = {R}_{c o m p r e s s i o n} + {R}_{d e c o m p r e s s i o n} + {R}_{inf e r e n c e} ,$$

where R_{compression} refers to the processing resources and memory reserved for model compression, R_{decompression} refers to the processing resources and memory reserved for decompression, and R_{inference} refers to the resources allocated for executing the AI/ML inference tasks, resulting in a total reservation of resources R_{total reserved} corresponding to the summation of the aforementioned three terms.

In some embodiments, an adjustment of compression strategies may be provided based on the energy availability of edge nodes. A dynamic selection may be provided between lossless and lossy compression to conserve resources. Nodes with high energy reserves may use lossless compression for enhanced (e.g., maximal) accuracy, while nodes with limited power may use lossy compression to conserve energy and extend operational longevity. In this respect, an energy-aware compression/decompression technique may be expressed as:

$${C}_{energy} = f ( {E}_{node} , compression type ) ,$$

where E_{node} represents the available energy at a node. A dynamic selection of the compression method/technique may be provided based on the energy status of each node, ensuring that the inference generation process is both energy-efficient and resource-aware.

In some embodiments, a Gen AI model may predict an enhanced (e.g., optimal) compression and decompression strategy for distributed inference generation based on real-time network/system metrics. The model may select between lossless and lossy compression based on a predicted load on/at each edge node, resource availability at the edge node, and the overall network/system conditions. A compression strategy that is utilized may be expressed as:

$${S}_{compression optimal} = GenAI ( {N}_{devices} , QoS , SINR , available resources )$$

where S_{compression optimal} may correspond to the optimal compression strategy selected by Gen AI. The foregoing expression may ensure adaptation to changing network/system conditions, maintaining efficient compression and decompression processes for real-time AI/ML inference generation. Of course, it is appreciated that a sub-optimal compression strategy may be utilized, such as for example in relation to trading-off various factors or parameters to achieve/realize particular results.

AI/ML model compression may be integrated with edge computing (e.g., multi-access edge computing [MEC]) and slicing techniques. Compression strategies may be adapted based on slice load, UE behavior, and service quality or degradation metrics. Lossless compression may be used in low-load, high-QoS slices, while lossy compression may be applied in heavily loaded slices to conserve resources and ensure rapid processing. A MEC/slicing compression CMEC may be expressed as:

$${C}_{MEC} = f ( slice load , UE behavior , QoS degradation , compression type ) ,$$

where slice load and QoS degradation may be used to determine the compression technique used in specific slices, ensuring that resources are allocated efficiently across slices in MEC environments.

In some embodiments, a dynamic selection between lossless and lossy compression may be based on real-time network/system and radio access metrics, ensuring that models are compressed and decompressed efficiently for real-time AI/ML inference generation. These metrics may include or pertain to: SINR, RSRP, CQI, sessions (e.g., PDU sessions), and PRB utilization. The dynamic compression optimization may be expressed as:

$${C}_{opt} = f ( SINR , RSRP , CQI , available resources , QoS ) ,$$

where Cₒₚₜ is the optimal compression strategy that may be selected based on real-time radio access metrics and resource availability. Models may be compressed appropriately for the network/system conditions to maintain both accuracy and efficiency.

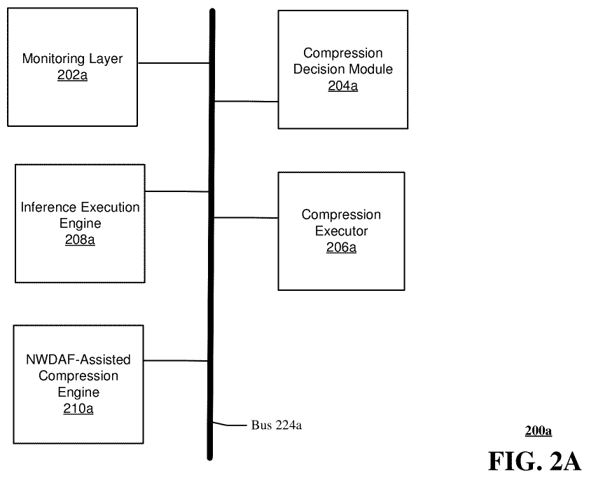

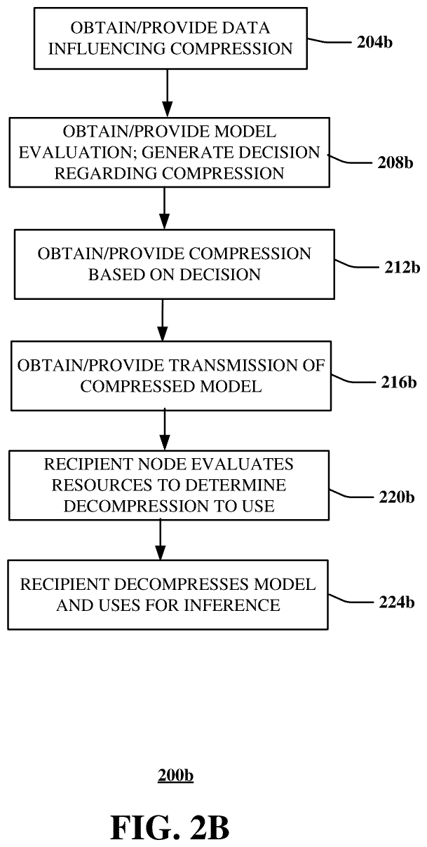

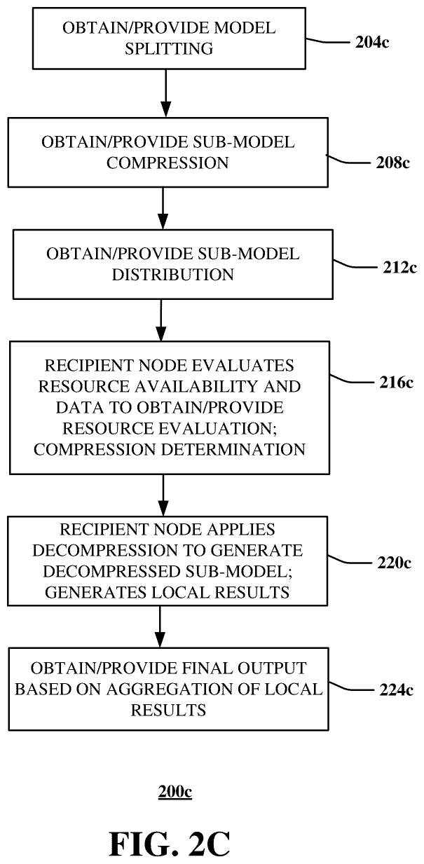

Aspects of this disclosure may be applied or utilized in respect of one or more platforms, topologies, or the like. To demonstrate, reference may now be made to FIG. 2A, which is a block diagram illustrating an example, non-limiting embodiment of a system 200a in accordance with various aspects described herein. In some embodiments, one or more parts/portions of the system 200a may be combined with, or operatively overlaid upon, one or more parts/portions of the system 100 of FIG. 1. The system 200a may be utilized to implement adaptive AI/ML model compression and decompression for inference generation/utilization and various strategies in respect of the same.

The system 200a may include a number of entities, such as for example a monitoring layer 202a, a compression decision module 204a, a compression executor 206a, an inference execution engine 208a, and a NWDAF-assisted compression engine 210a. The entities shown in FIG. 2A are illustrative, which is to say that more or fewer entities may be included in a given embodiment. Furthermore, functionality associated with a first of the entities may be redistributed to one or more of the other entities without any loss of accuracy in this description. The entities are shown in FIG. 2A as being communicatively coupled to one another via a bus 224a. The use of a bus 224a is illustrative, which is to say that other forms or mediums of communication for sharing information or data, such as channels or links, between two or more of the entities may be utilized.

The monitoring layer 202a may be responsible for tracking real-time data related to network/system conditions (which may be represented as metrics pertaining to: bandwidth, latency, SINR, CQI, and throughput, for example) and resource availability (which may be represented as, or pertain to: processing load, memory capacity, power/energy levels at edge nodes, and bandwidth usage or capacity, for example). The data generated by the monitoring layer 202a may be continuously provided to the compression decision module 204a and/or the NWDAF 210a to guide real-time decisions about model compression and decompression. The monitoring layer 202a may provide feedback on the trustworthiness of the inference generation process by ensuring that the models used are not corrupted and that the communication between nodes maintain integrity.

The compression decision module 204a may analyze data obtained from the monitoring layer 202a and the NWDAF 210a to determine whether to apply compression or decompression based on the availability of network and device resources, along with predictions of network/system conditions provided by the NWDAF 210a. Compression may be triggered/initiated when predefined resource thresholds (e.g., low processing resources or bandwidth) are reached, or when the NWDAF 210a anticipates resource limitations due to high network traffic or congestion. In this respect, the NWDAF 210a may provide, to the compression decision module 204a, predictive insights by analyzing traffic patterns, mobility behaviors, and QoS metrics. This information may allow the compression decision module 204a to proactively select the appropriate compression level (lossless or lossy) based on expected future network/system conditions.

The compression executor 206a may execute the decisions made by the compression decision module 204a. The compression executor 206a may handle both lossless compression and lossy compression, depending on a task's criticality and available resources. Lossless compression may be used to preserve model fidelity in critical tasks where accuracy is paramount. Lossy compression may be applied to save memory and bandwidth when resources are constrained or NWDAF 210a predicts increased network/system congestion. The compression executor 206a may ensure that models are compressed and decompressed efficiently to enhance (e.g., optimize) resource usage without compromising overall performance or accuracy (where required).

The inference execution engine 208a may be responsible for scheduling and running AI/ML inference tasks on edge nodes. The engine 208a may be designed to balance computational load across nodes while ensuring that real-time performance objectives are met. Functionalities and/or features of the engine 208a may include resource-aware scheduling and trustworthiness and accuracy. In terms of resource-aware scheduling, the engine 208a may dynamically assign tasks to nodes based on real-time resource availability (e.g., processing resources, memory, energy, bandwidth) and NWDAF 210a insights, ensuring that no node is overburdened. These techniques may be used to reduce (e.g., avoid) resource bottlenecks and reduce (e.g., minimize) latency in inference execution. In terms of trustworthiness and accuracy, the engine 208a may ensure that data and models being used are trustworthy and accurate. For mission-critical tasks, lossless compression may be applied to maintain model accuracy, while less critical tasks may be allocated or assigned to utilize lossy compression.

The NWDAF 210a may provide predictive analytics about the network/system environment to assist in determining an appropriate level of compression. NWDAF 210a may gather and analyze information pertaining to network/system traffic load, QoS metrics, and mobility patterns. In terms of network/system traffic load, a prediction may be generated by the NWDAF 210a of future congestion or load spikes, prompting compression overhead reduction strategies by switching to lossy compression if necessary. In terms of QoS metrics, the NWDAF 210a may analyze QoS requirements for different services and dynamically adjust the compression level to meet or exceed the expected service quality. In terms of mobility patterns, the NWDAF 210a may anticipate how device mobility (e.g., handovers) may impact network/system connectivity and inform/advise as to how to prepare for potential bandwidth fluctuations via a selection of an appropriate compression strategy under the circumstances.

In some embodiments, analytics may be utilized to detect congestion levels, such as congestion levels associated with a control plane or a user/data plane at a radio access network (RAN) level, at a core network level, etc. In some embodiments, a client operating on behalf of the NWDAF 210a may determine or identify actual or anticipated congestion levels on certain resources (e.g., certain cells or groups of cells). Based on the congestion level(s) that are reported/generated, a compression level may be appropriately selected. Further, in terms of timing, the implementation of a given compression level may be a function of current status and/or predicted status of a network/system.

Referring now to FIG. 2B, an illustrative embodiment of a method 200b in accordance with aspects of this disclosure is shown. The method 200b may be implemented or executed, in whole or in part, in conjunction with one or more systems, devices, and/or components. In this regard, aspects of the method 200b may be described below in relation to the system 200a of FIG. 2A described above, with the understanding that aspects of the method 200b may be practiced in respect of other systems. The method 200b may facilitate dynamic AI/ML model compression based on resource availability and NWDAF insights. Various operations of the method 200b are described below in relation to the blocks shown in FIG. 2B.

In block 204b, data may be obtained/provided in respect of a compression decision. For example, as part of block 204b, and when an AI/ML model is loaded for inference generation/execution, the monitoring layer 202 may collect real-time network/system and resource data, passing the data to the compression decision module 204a and the NWDAF 210a. As described above, the NWDAF 210a may process the data and provide predictions on future network/system congestion, mobility, and traffic loads.

In block 208b, a model evaluation may be obtained/provided. For example, as part of block 208b an evaluation may be undertaken in terms of a current state of a model, available resources and NWDAF 210a predictions, and a decision may be made whether to apply lossless or lossy compression.

In block 212b, compression may be obtained/provided based on the decision of block 208b. For example, block 212b may include application of losses or lossy compression in the manner set forth above.

In block 216b, a transmission of the compressed model (of block 212b) may be obtained/provided. For example, as part of block 216b, the compressed model may be transmitted to an appropriate inference node, either in a same edge location or to a neighboring edge node, depending on distributed inference requirements.

In block 220b, a resource check/validation may be obtained/provided. For example, a recipient node of the transmission (of block 216b) may evaluate its resources and NWDAF insights to determine whether to use lossless or lossy decompression.

In block 224b, the recipient node may apply decompression in accordance with the determination of block 220b to generate a decompressed model. The decompressed model may be used for purposes of inference generation and may generate and transmit/provide results in respect of the same.

Referring now to FIG. 2C, an illustrative embodiment of a method 200c in accordance with aspects of this disclosure is shown. The method 200c may be implemented or executed, in whole or in part, in conjunction with one or more systems, devices, and/or components. In this regard, aspects of the method 200c may be described below in relation to the system 200a of FIG. 2A described above, with the understanding that aspects of the method 200c may be practiced in respect of other systems. The method 200c may facilitate a distributed inference generation across geo-located edge nodes. Various operations of the method 200c are described below in relation to the blocks shown in FIG. 2C.

In block 204c, a model splitting may be obtained/provided. For example, as part of block 204c and when an AI/ML model is determined to be too large or complex to run on a single edge node, the model may be split or subdivided into smaller sub-models as described above. The NWDAF 210a may be used to provide insight into whether lossless or lossy compression should be applied to one or more of the sub-models.

In block 208c, sub-model compression may be obtained/provided. Each sub-model may be compressed as part of block 208c based on network conditions and resource availability at a transmitting node.

In block 212c, a sub-model distribution may be obtained/provided. The compresses sub-models may be transmitted across geographically distributed edge nodes. Assurances may be provided that sub-models are directed to nodes with sufficient resources to handle them.

In block 216c, and upon receiving a sub-model (based on the distribution of block 212c), a recipient node (e.g., a recipient edge node) may evaluate its resource availability and NWDAF data to obtain/provide a resource evaluation. This resource evaluation of block 216c may be used to determine/decide if lossless or lossy decompression should be applied.

In block 220c, each recipient node may obtain/provide a decompression of the sub-model based on the determination/decision of block 216c, resulting in a decompressed sub-model. As part of block 220c, the decompressed sub-model may be used for purposes of local inference generation and may generate and transmit/provide local results.

In block 224c, the local results of block 220c may be combined/aggregated, and sent back to an originating node, resulting in a final output of the distributed inference generation being obtained/provided.

While for purposes of simplicity of explanation, the respective processes are shown and described as a series of blocks in FIG. 2B-2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. While described and shown separately, in some embodiments one or more aspects of the method 200b may be combined with one or more aspects of the method 200c. In some embodiments, one or more blocks or operations may be based on one or more other blocks or operations.

In some embodiments, aspects of the method 200b and/or the method 200c may be wholly or partially implemented or executed via one or more processing systems, where each such processing system may include one or more processors. Further, in some embodiments, operations of the method 200b and/or the method 200c may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc.

In accordance with aspects of this disclosure, adaptive AI/ML model compression and decompression techniques (e.g., pruning, quantization, knowledge distillation) may be employed at geolocated edge nodes in 5G, 6G, and future networks. A compression technique that is selected may be dynamically adjusted based on real-time network/system data/metrics, radio metrics, and/or NWDAF insights.

In some embodiments, Geo-AI models may be trained at a network/system edge using local geographical data and mobility metrics such as TAI, Cell ID, and handover events. This may enable AI/ML models to account for region-specific characteristics and mobility related data that could impact inference accuracy. After training, the models may be dynamically compressed before transmission to other nodes or for storage purposes. The compression strategy used (whether lossless or lossy) may depend on network/system conditions such as SINR, CQI, RSRP, throughput, and PRB utilization. Upon reception, the models may be decompressed for use in inference generation. Lossless compression may be preferred when resource availability is high (e.g., greater than a threshold), ensuring enhanced (e.g., maximum) accuracy. However, lossy compression may be applied when resources are constrained, striking a balance between speed and precision.

For complex AI/ML models that cannot be fully processed by a single edge node, a dynamic split/sub-divide of a model into sub-models may be obtained/provided. The sub-models may be distributed across multiple geo-located edge nodes. These sub-models may be compressed during transmission to reduce bandwidth usage and ensure timely delivery. Lossless compression may be applied in scenarios where resource availability allows, preserving the full accuracy of the sub-models. Lossy compression may be used in environments with constrained resources or high device density. After transmission, a receiving/recipient node may decompress a sub-model and collaborate to perform distributed inference generation. This may help to ensure that even in resource-constrained environments, AI/ML tasks can still be performed efficiently by sharing an associated workload across multiple nodes. The final results may be aggregated and sent back to an originating node for further processing or decision-making.

In some embodiments, runtime resources (e.g., CPU or processing resources, memory, bandwidth, power, etc.) may be reserved for compression, decompression, and inference tasks based on real-time network/system parameters, including identifications/indications of sessions (e.g., PDU sessions), connection density, QoS requirements, and slicing metrics. These resources may be allocated based on real-time monitoring of a network/system environment and adjusted to ensure that AI/ML tasks can be performed with reduced (e.g., minimal) latency. For example, in a congested network where PDU sessions are high, additional bandwidth may be reserved for lossy compression to conserve resources, while in low-latency scenarios, more CPU/processing and memory resources may be allocated for lossless compression to preserve model accuracy. These techniques may ensure that resource contention is reduced (e.g., minimized) and that AI/ML models can be efficiently processed regardless of network/system conditions.

Aspects of this disclosure may provide for dynamically adjusting compression and decompression strategies based on the energy availability of distributed edge nodes. Nodes with higher energy reserves may use lossless compression, ensuring enhanced (e.g., maximum) accuracy during inference tasks. In contrast, energy-limited nodes may employ lossy compression to conserve power and computational resources while still maintaining acceptable levels of inference performance. This approach is critical for scenarios where nodes have limited energy resources, such as in remote or battery-operated devices. A monitoring of reports, such as power headroom reports (PHRs), and transmission power, may be provided to enhance (e.g., optimize) the use of energy-efficient compression techniques.

Gen AI models may be leveraged to predict enhanced (e.g., optimal) compression and decompression strategies for distributed inference tasks across edge nodes. Based on real-time network/system conditions (e.g., connection density, QoS requirements, SINR, RSRP, CQI, latency, throughput, and resource block utilization), a dynamic/adaptive selection may be realized in terms of whether to use lossless or lossy compression. Gen AI may enhance (e.g., optimize) model distribution across nodes by predicting which nodes should handle specific parts of the model based on their available resources and network/system conditions. For example, in high-throughput, low-latency environments, lossless compression may be selected to maintain model fidelity, while in resource-constrained environments tolerant of higher latency, lossy compression may be chosen to reduce (e.g., minimize) resource usage.

AI/ML compression may be integrated MEC and slicing to provide efficient inference tasks across diverse network/system environments. MEC nodes may dynamically adjust their model compression strategies based on slice load levels, UE behavior, and service quality/degradation metrics. When a slice is under heavy load or experiencing service degradation (e.g., high packet loss, jitter), lossy compression may applied to reduce processing time and resource consumption. In low-load, high-QoS slices, lossless compression may be used to enhance (e.g., maximize) the accuracy of AI/ML inference tasks. These techniques may ensure that MEC environments can efficiently manage varying workloads while still providing real-time inference capabilities.

In some embodiments, a dynamic adjustment of model compression and decompression strategies may be realized/obtained for real-time AI/ML inference tasks based on real-time network/system conditions, including device connection density, PDU sessions, QoS, radio access metrics (e.g., SINR, RSRP, CQI, RLF), and resource block utilization. A monitoring of these, and other, metrics may be provided to dynamically choose/select between lossless and lossy compression to ensure enhanced (e.g., optimal) performance and resource efficiency. For example, in a low-SINR environment with high device density, lossy compression may be used to maintain inference task performance without overloading the network/system. Conversely, in high-SINR, low-density environments, lossless compression may be selected to maintain model fidelity without compromising network/system resources.

As described above, aspects of this disclosure may be utilized to balance competing interests, such as resource conservation/preservation and quality/accuracy in modeling. Aspects of this disclosure may be applied in respect of network/system infrastructure, such as infrastructure that may be used to “power” smart cities, autonomous vehicles, connected devices (e.g., Internet of Things devices or sensors), etc. Still further, latency-sensitive communication services/applications, such as voice calls, video conferencing, gaming, video streaming, augmented/virtual reality, and the like, may benefit from aspects of this disclosure. Devices or applications that are sensitive to power dissipation or battery life may benefit as well.

Aspects of this disclosure may be utilized or applied in respect of a multitude of inference tasks, such as inference generation. Inferences may include the results or outputs that may be generated by/via one or more models, algorithms, or the like. As described herein, inference tasks may be allocated to edges of a network or system, which may be beneficial for purposes of reducing latency. To the extent that edge nodes/devices are limited in terms of resources, a simplified or compressed model may be sufficient for executing various tasks and generating outputs that may support various communication services, sessions, applications, and the like. In brief, inference times may be reduced with little to no sacrifice being made in terms of quality or accuracy.

In some embodiments, a gold standard or gold model may be maintained at a centralized location (e.g., a core node of a network or system). Versions of such models located proximally to an edge of the network/system may need to be updated, such as in relation to changes in network/system circumstances or conditions. For example, if significant network/system changes occur, the model may need to be updated at or near the edge to more accurately reflect the changes. This implies that the frequency of updates may depend on the network/system conditions and the need (if any) to adapt to changes. In some embodiments, updates may be scheduled or pushed to the edge at a given rate or frequency. In some embodiments, edge nodes or devices may be empowered/enabled to pull updates from the centralized location.

Aspects of this disclosure provide an ability to dynamically compress and decompress AI/ML models based on available resources at, e.g., edge nodes. This approach allows models to run efficiently in resource-constrained environments, reducing storage requirements and computational needs, which leads to faster response times. Aspects of this disclosure address and facilitate a trade-off between resource conservation and quality or accuracy by choosing between lossy and lossless compression depending on the available resources. This dynamic adaptation ensures that models can be deployed effectively on edge nodes, striking an appropriate balance between enhancing performance and reducing latency on the one hand, and enhancing resource efficiencies on the other hand.

In view of the foregoing description, one of skill in the art will appreciate that the various aspects of this disclosure are integrated as part of numerous practical applications involving a provisioning of communication services and sessions in respect of resources of a communication network or system. Indeed, the various aspects of this disclosure may facilitate an efficient utilization of scarce resources to provision such communication services and sessions, and therefore, represent substantial improvements to technology. In this regard, the various aspects of this disclosure are not directed to abstract ideas. To the contrary, the various aspects of this disclosure are directed to, and encompass, significantly more than any abstract idea standing alone. As one of skill in the art will appreciate based on a review of this disclosure, the various aspects of this disclosure may be used to generate useful, concrete, tangible, and transformative results, representing a major paradigm shift relative to the conventional state of the art.

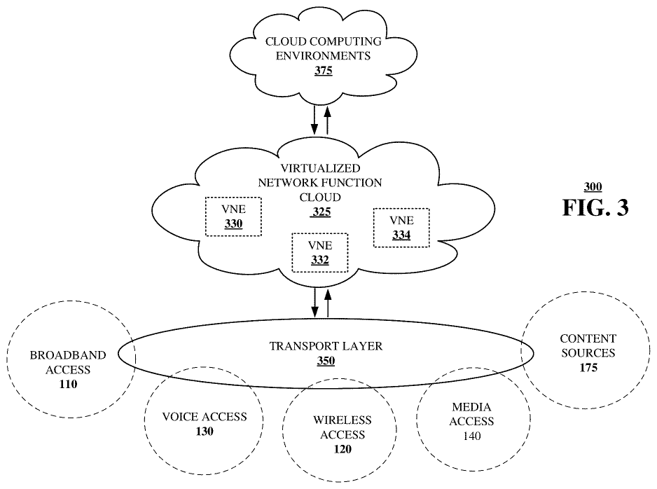

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and methods 200b and 200c presented in FIGS. 1, 2A, 2B, and 2C. For example, the virtualized communication network 300 can facilitate, in whole or in part, identifying resources available at an edge node of a network, resulting in a first identification, identifying at least one requirement associated with a communication service facilitated by the edge node, resulting in a second identification, determining, based on the first identification and the second identification, a first compression that is to be applied to a model that facilitates the communication service, resulting in a determination, applying, based on the determination, the first compression to the model, resulting in a compressed model, and providing the compressed model to the edge node. The virtualized communication network 300 can facilitate, in whole or in part, obtaining first data pertaining to real-time network data and resource data associated with a network, obtaining second data pertaining to a prediction of congestion, mobility, and traffic loads as part of the network, processing the first data and the second data to identify a compression that is to be applied to a model supporting a communication service provisioned by the network, applying the compression to the model, resulting in a compressed model, and transmitting the compressed model to a node of the network. The virtualized communication network 300 can facilitate, in whole or in part, obtaining, by a processing system including a processor, a compressed model, evaluating, by the processing system, resources available at the processing system to identify a decompression that is to be applied to the compressed model, resulting in an identified decompression, decompressing, by the processing system, the compressed model in accordance with the identified decompression, resulting in a decompressed model, and utilizing, by the processing system, the decompressed model to generate an inference.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

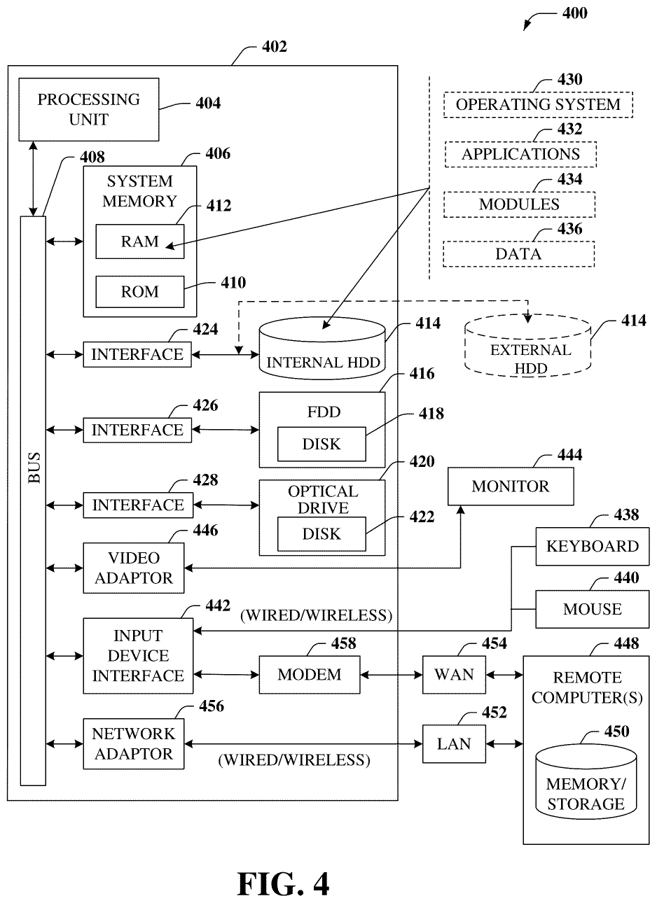

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, identifying resources available at an edge node of a network, resulting in a first identification, identifying at least one requirement associated with a communication service facilitated by the edge node, resulting in a second identification, determining, based on the first identification and the second identification, a first compression that is to be applied to a model that facilitates the communication service, resulting in a determination, applying, based on the determination, the first compression to the model, resulting in a compressed model, and providing the compressed model to the edge node. The computing environment 400 can facilitate, in whole or in part, obtaining first data pertaining to real-time network data and resource data associated with a network, obtaining second data pertaining to a prediction of congestion, mobility, and traffic loads as part of the network, processing the first data and the second data to identify a compression that is to be applied to a model supporting a communication service provisioned by the network, applying the compression to the model, resulting in a compressed model, and transmitting the compressed model to a node of the network. The computing environment 400 can facilitate, in whole or in part, obtaining, by a processing system including a processor, a compressed model, evaluating, by the processing system, resources available at the processing system to identify a decompression that is to be applied to the compressed model, resulting in an identified decompression, decompressing, by the processing system, the compressed model in accordance with the identified decompression, resulting in a decompressed model, and utilizing, by the processing system, the decompressed model to generate an inference.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

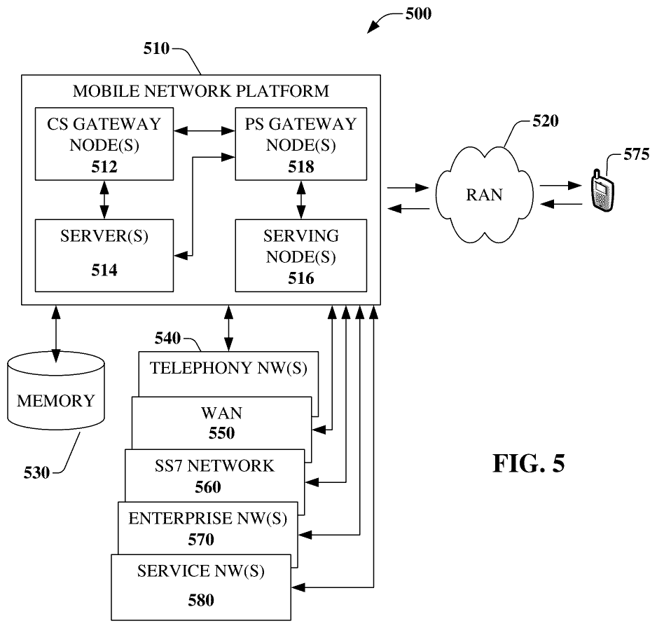

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, identifying resources available at an edge node of a network, resulting in a first identification, identifying at least one requirement associated with a communication service facilitated by the edge node, resulting in a second identification, determining, based on the first identification and the second identification, a first compression that is to be applied to a model that facilitates the communication service, resulting in a determination, applying, based on the determination, the first compression to the model, resulting in a compressed model, and providing the compressed model to the edge node. The platform 510 can facilitate, in whole or in part, obtaining first data pertaining to real-time network data and resource data associated with a network, obtaining second data pertaining to a prediction of congestion, mobility, and traffic loads as part of the network, processing the first data and the second data to identify a compression that is to be applied to a model supporting a communication service provisioned by the network, applying the compression to the model, resulting in a compressed model, and transmitting the compressed model to a node of the network. The platform 510 can facilitate, in whole or in part, obtaining, by a processing system including a processor, a compressed model, evaluating, by the processing system, resources available at the processing system to identify a decompression that is to be applied to the compressed model, resulting in an identified decompression, decompressing, by the processing system, the compressed model in accordance with the identified decompression, resulting in a decompressed model, and utilizing, by the processing system, the decompressed model to generate an inference.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

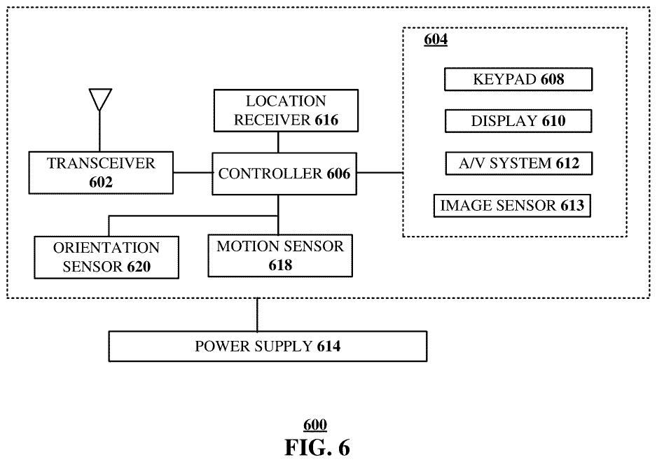

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, identifying resources available at an edge node of a network, resulting in a first identification, identifying at least one requirement associated with a communication service facilitated by the edge node, resulting in a second identification, determining, based on the first identification and the second identification, a first compression that is to be applied to a model that facilitates the communication service, resulting in a determination, applying, based on the determination, the first compression to the model, resulting in a compressed model, and providing the compressed model to the edge node. The computing device 600 can facilitate, in whole or in part, obtaining first data pertaining to real-time network data and resource data associated with a network, obtaining second data pertaining to a prediction of congestion, mobility, and traffic loads as part of the network, processing the first data and the second data to identify a compression that is to be applied to a model supporting a communication service provisioned by the network, applying the compression to the model, resulting in a compressed model, and transmitting the compressed model to a node of the network. The computing device 600 can facilitate, in whole or in part, obtaining, by a processing system including a processor, a compressed model, evaluating, by the processing system, resources available at the processing system to identify a decompression that is to be applied to the compressed model, resulting in an identified decompression, decompressing, by the processing system, the compressed model in accordance with the identified decompression, resulting in a decompressed model, and utilizing, by the processing system, the decompressed model to generate an inference.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
identifying resources available at an edge node of a network, resulting in a first identification;
identifying at least one requirement associated with a communication service facilitated by the edge node, resulting in a second identification;
determining, based on the first identification and the second identification, a first compression that is to be applied to a model that facilitates the communication service, resulting in a determination;
applying, based on the determination, the first compression to the model, resulting in a compressed model; and
providing the compressed model to the edge node.

2. The device of claim 1, wherein the identifying of the resources available at the edge node comprises identifying processing resources available at the edge node, memory available at the edge node, and bandwidth available at the edge node.

3. The device of claim 2, wherein the identifying of the resources available at the edge node comprises identifying energy available at the edge node.

4. The device of claim 1, wherein the identifying of the at least one requirement comprises identifying a throughput associated with the communication service, a latency associated with the communication service, and a tolerable jitter associated with the communication service.

5. The device of claim 1, wherein the determining is further based on an identification of: a number of connected devices, a number of sessions, quality of service (QoS) requirements, mobility metrics, radio access metrics, throughput and data rate parameters, resource block utilization parameters, power reports, signaling overhead, and slicing metrics.

6. The device of claim 1, wherein the applying of the first compression to the model comprises applying lossless compression to the model.

7. The device of claim 1, wherein the applying of the first compression to the model comprises applying lossy compression to the model.

8. The device of claim 1, wherein the providing of the compressed model to the edge node causes the edge node to decompress the compressed model, resulting in a decompressed model that is used by the edge node to generate an inference.

9. The device of claim 1, wherein the operations further comprise:
dividing a second model into a plurality of sub-models, wherein the model is a first sub-model of the plurality of sub-models.

10. The device of claim 9, wherein the operations further comprise:
identifying second resources available at a second edge node of the network, resulting in a third identification;
identifying at least a second requirement associated with a second communication service facilitated by the second edge node, resulting in a fourth identification;
determining, based on the third identification and the fourth identification, a second compression that is to be applied to a second sub-model of the plurality of sub-models that facilitates the second communication service, resulting in a second determination;
applying, based on the second determination, the second compression to the second sub-model, resulting in a second compressed model; and
providing the second compressed model to the second edge node.

11. The device of claim 10, wherein the second compression is different from the first compression.

12. The device of claim 10, wherein the operations further comprise:
obtaining, from the edge node and based on the providing of the compressed model to the edge node, a first result;
obtaining, from the second edge node and based on the providing of the second compressed model to the second edge node, a second result; and
generating an aggregate result that is based on the first result and the second result, the aggregate result corresponding to the second model.

13. The device of claim 1, wherein the operations further comprise:
subsequent to the providing of the compressed model to the edge node, determining that a change has occurred in the network, resulting in a second determination;
modifying, based on the second determination, the model, resulting in a modified model that is different from the model;
applying the first compression to the modified model, resulting in a compressed modified model; and
providing the compressed modified model to the edge node such that the edge node replaces a decompressed version of the compressed model with a decompressed version of the compressed modified model.

14. A non-transitory machine-readable medium, comprising executable instructions that, when executed by a processing system including a processor, facilitate performance of operations, the operations comprising:
obtaining first data pertaining to real-time network data and resource data associated with a network;
obtaining second data pertaining to a prediction of congestion, mobility, and traffic loads as part of the network;
processing the first data and the second data to identify a compression that is to be applied to a model supporting a communication service provisioned by the network;
applying the compression to the model, resulting in a compressed model; and
transmitting the compressed model to a node of the network.

15. The non-transitory machine-readable medium of claim 14, wherein the compression is a lossless compression.

16. The non-transitory machine-readable medium of claim 14, wherein the compression is a lossy compression.

17. The non-transitory machine-readable medium of claim 14, wherein the transmitting of the compressed model causes the node to decompress the compressed model to generate a decompressed model for use at the node in conjunction with a generation of an inference.

18. The non-transitory machine-readable medium of claim 14, wherein the prediction is based on a use of machine learning, artificial intelligence, or a combination thereof.

19. A method, comprising:
obtaining, by a processing system including a processor, a compressed model;
evaluating, by the processing system, resources available at the processing system to identify a decompression that is to be applied to the compressed model, resulting in an identified decompression;
decompressing, by the processing system, the compressed model in accordance with the identified decompression, resulting in a decompressed model; and
utilizing, by the processing system, the decompressed model to generate an inference.

20. The method of claim 19, wherein a compression that is applied to a model that resulted in the compressed model is based on a plurality of parameters, and wherein the plurality of parameters pertain to: a signal to interference plus noise ratio (SINR), a reference signal received power (RSRP), and a channel quality indicator (CQI).
